(19) United States
(12) Patent Application Publication
(10) Pub. No.: US 2024/0142743 A1
(43) Pub. Date: May 2, 2024

(54) OPTICAL APPARATUS AND ADJUSTMENT METHOD

(71) Applicants: NEC Corporation, Tokyo (JP); NEC Platforms, Ltd., Kawasaki-shi (JP)

(72) Inventors: Issei SHIDA, Kanagawa (JP); Kenichi KURATA, Kanagawa (JP)

(73) Assignees: NEC Corporation, Tokyo (JP); NEC Platforms, Ltd., Kawasaki-shi (JP)

(21) Appl. No.: 18/214,436

(22) Filed: Jun. 26, 2023

(30) Foreign Application Priority Data
Oct. 28, 2022 (JP) 2022-173807

(51) Int. Cl. G02B 7/02

(52) U.S. Cl. CPC G02B 7/027

(57) ABSTRACT

An optical apparatus that allows easy adjustment of the position of an optical unit is provided. An optical apparatus (1) includes: a ball lens (10); an optical unit (20); a base (30); and a cover (40). The optical unit (20) includes a magnet (21), and is mounted on the base (30) so as to rotate around the ball lens (10) in response to magnetic force by which the magnet (21) is attracted.

This Nonprovisional application claims priority under 35 U.S.C. § 119 on Patent Application No. 2022-173807 filed in Japan on Oct. 28, 2022, the entire contents of which are hereby incorporated by reference.

### TECHNICAL FIELD

The present invention relates to a technique for adjusting the position of an optical apparatus.

### BACKGROUND ART

An optical apparatus including a ball lens and an optical unit is applied to a transmission light-receiving optical apparatus, such as laser application equipment intended for laser communications between a plurality of apparatuses.

Here is the description of an example of the conventional optical apparatus as above, with reference to FIGS. 11 and 12. FIG. 11 is a sectional side view of an example of a conventional optical apparatus 1X. FIG. 12 is a top view of an example of the conventional optical apparatus 1X. As illustrated in FIGS. 11 and 12, the optical apparatus 1X includes a ball lens 10X, an optical unit 20X, and a base 30X on which the ball lens 10X and the optical unit 20X are mounted. The optical apparatus 1X has the mechanism by which the ball lens 10X receives and collects transmission light L outputted from an external source such as another apparatus, and the optical unit 20X receives the transmission light L having been collected (FIGS. 11 and 12).

In relation to such an optical apparatus, Patent Literature 1 discloses the technique in which a beam splitter and a light-receiving element for a reception signal are provided on a seat, and laser light outputted from an optical fiber first passes through a ball lens, and is then reflected by the beam splitter and enters the light-receiving element for a reception signal.

### CITATION LIST

### Patent Literature

[Patent Literature 1]
Japanese Patent Application Publication, Tokukai, No. 2006-80362

### SUMMARY OF INVENTION

### Technical Problem

Incidentally, the direction of the transmission light changes depending on the positions of the ball lens, etc. of the optical apparatus. It is therefore required that the position of the optical unit be easily adjusted according to the direction (FIG. 12).

However, there is a problem with the technique disclosed in Patent Literature 1, the problem of being incapable of easily adjusting the position of the optical unit because the light-receiving element for a reception signal is mounted on the seat.

An aspect of the present invention has been made in view of the above problem, and an example object thereof is to provide an optical apparatus and related techniques, the optical apparatus allowing easy adjustment of the position of an optical unit.

### Solution to Problem

An optical apparatus in accordance with an aspect of the present invention includes: a ball lens that receives and collects transmission light outputted from an external source; at least one optical unit that receives the transmission light having been collected; a base on which the ball lens and the at least one optical unit are mounted; and a cover that engages with the base to house the ball lens and the at least one optical unit, the at least one optical unit including a magnet, and being mounted on the base so as to be capable of rotating around the ball lens in response to magnetic force by which the magnet is attracted.

An adjustment method in accordance with an aspect of the present invention is a method for adjusting a position of at least one optical unit included in an optical apparatus, the optical apparatus further including: a ball lens that receives and collects transmission light outputted from an external source; a base on which the ball lens and the at least one optical unit are mounted; and a cover that engages with the base to house the ball lens and the at least one optical unit, the at least one optical unit receiving the transmission light having been collected, the at least one optical unit being mounted on the base so as to be capable of rotating around the ball lens, the at least one optical unit including a magnet, the method comprising causing the magnet to be attracted by magnetic force exerted from outside the cover to rotate the at least one optical unit around the ball lens.

### Advantageous Effects of Invention

With an aspect of the present invention, it is possible to provide an optical apparatus and related techniques, the optical apparatus allowing easy adjustment of the position of the optical unit.

### BRIEF DESCRIPTION OF DRAWINGS

FIG. 1 is a sectional side view of an example of an optical apparatus in accordance with a first example embodiment of the present invention.

FIG. 2 is a perspective view of an example of the optical apparatus in accordance with the first example embodiment of the present invention.

FIG. 3 is a top view of an example of the optical apparatus in accordance with the first example embodiment of the present invention.

FIG. 4 is a sectional side view of an example of an optical apparatus in accordance with a second example embodiment of the present invention.

FIG. 5 is a perspective view of an example of the optical apparatus in accordance with the second example embodiment of the present invention.

FIG. 6 is a perspective view of an example of the optical apparatus in accordance with the second example embodiment of the present invention.

FIG. 7 is a perspective view of an example of the optical apparatus in accordance with the second example embodiment of the present invention.

FIG. 8 is a perspective view of an example of the optical apparatus in accordance with the second example embodiment of the present invention.

FIG. 9 is an enlarged sectional side view of an example of the optical apparatus in accordance with the second example embodiment of the present invention.

FIG. 10 is a top view of an example of the optical apparatus in accordance with the second example embodiment of the present invention.

FIG. 11 is a sectional side view of an example of a conventional optical apparatus.

FIG. 12 is a top view of an example of the conventional optical apparatus.

FIG. 13 is a perspective view of an example of the conventional optical apparatus.

FIG. 14 is a perspective view of an example of the conventional optical apparatus.

### EXAMPLE EMBODIMENTS

### Problem to be Solved by Example Embodiments

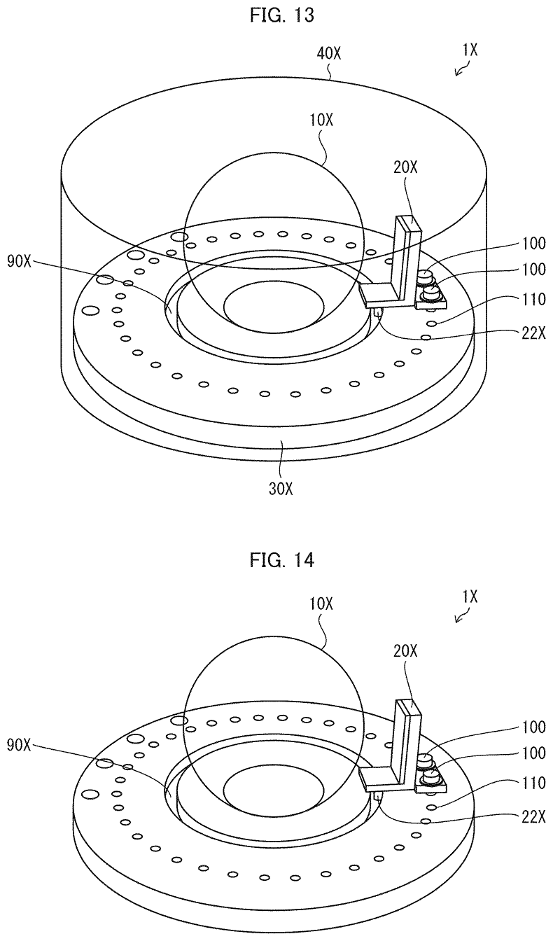

The following description will discuss the problem to be solved by example embodiments. Taken for instance in the description is a problem in adjusting the position of an optical unit 20X of a conventional optical apparatus 1X illustrated in FIGS. 13 and 14.

FIGS. 13 and 14 are perspective views of an example of the conventional optical apparatus 1X. In the example illustrated in FIGS. 13 and 14, the conventional optical apparatus 1X includes a ball lens 10X, an optical unit 20X, a base 30X, a cover 40X, and fixing portions (fixing means) 100 and 110.

In the example illustrated in FIGS. 13 and 14, the base 30X has a groove 90X formed around the part in which the ball lens 10X is mounted, and an abutting part 22X which forms a part of the optical unit 20X is inserted in the groove 90X. With this configuration, the optical unit 20X is mounted on the base 30X so as to be capable of rotating around the ball lens 10X along the groove 90X. The fixing portions 100 and 110 fix the position of the optical unit 20X. In the example illustrated in FIGS. 13 and 14, the fixing portion 100 is a screw and the fixing portion 110 is a screw hole.

In adjusting the position of the optical unit 20X in the conventional optical apparatus 1X, the user of the optical apparatus 1X starts with removal of the cover 40X, in order to bring the state of the optical apparatus 1X from the state illustrated in FIG. 13 to the state illustrated in FIG. 14. Next, for the conventional optical apparatus 1X, the user removes the screw 100, which fixes the optical unit 20X, to cause the optical unit 20X to rotate around the ball lens 10X, in order to adjust the position of the optical unit 20X. In addition, for the conventional optical apparatus 1X, after the position of the optical unit 20X is adjusted so as to be in a specific position at which to receive transmission light L having been received and collected by the ball lens 10X, the user fixes the optical unit 20X in the specific position with the screw 100, and closes the cover 40X.

As above, there is a problem with the conventional optical apparatus 1X in adjusting the position of the optical unit 20X, the problem of being incapable of moving the optical unit 20X and therefore incapable of adjusting the position of the optical unit 20X unless the user removes the cover 40X and removes the fixing portion 100, such as a screw. In addition, there is the problem of a reduction in work efficiency because the adjustment of the position of the optical unit 20X requires use of a tool.

Laser application equipment in which an optical apparatus such as the optical apparatus 1X is used is typically designed for outdoor use, and the adjustment of the position of the optical unit 20X is carried out outdoors. For this reason, it is necessary to maintain airtightness to prevent sandy dust, dew, or the like from entering the optical apparatus 1X, in order to decrease the influence of sandy dust, dew, and the like, and the positional adjustment and fixation of the optical unit 20X under hermetically sealed conditions are required. However, there is a problem with a method for positional adjustment and fixation of the optical unit 20X under hermetically sealed conditions, the problem of a limited environment in which the position of the optical unit 20X is adjusted.

Furthermore, using a movable section such as a motor to solve the above problems causes the problem of a shortened life of the optical apparatus 1X.

Thus, a problem to be solved by the example embodiments is to provide an optical apparatus and related techniques, the optical apparatus allowing easy adjustment of the position of an optical unit. Another problem to be solved by the example embodiments is to provide an optical apparatus and related techniques, the optical apparatus allowing easy adjustment of the position of an optical unit without removal of a fixing portion such as a screw. Another problem to be solved by the example embodiments is to provide an optical apparatus and related techniques, the optical apparatus requiring no tool for adjusting the position of an optical unit, thereby allowing an improvement in work efficiency. Still another problem to be solved by the example embodiments is to provide an optical apparatus and related techniques, the optical apparatus allowing adjustment of the position of an optical unit while maintaining airtightness, whether outdoors or in any other location. Yet another problem to be solved by the example embodiments is to provide an optical apparatus and related techniques, the optical apparatus allowing adjustment of the position of an optical unit without the use of a movable section such as a motor, thereby extending the life of the optical apparatus.

### First Example Embodiment

The following description will discuss a first example embodiment of the present invention in detail, with reference to the drawings. The present example embodiment is basic to the example embodiments that will be described later.

(Configuration of Optical Apparatus 1)

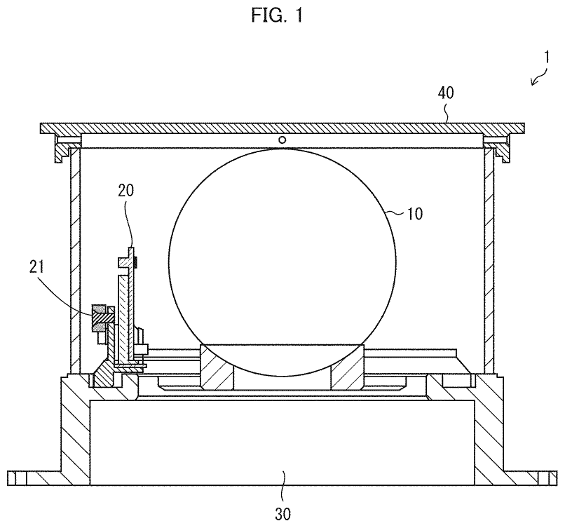

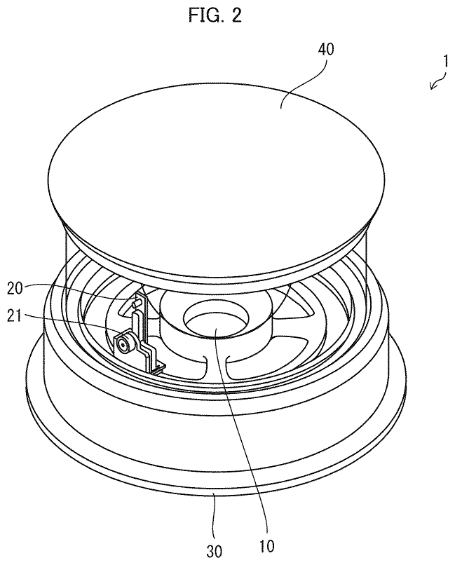

The configuration of an optical apparatus 1 in accordance with the present example embodiment will be described below, with reference to FIGS. 1 and 2. FIG. 1 is a sectional side view of an example of the optical apparatus 1. FIG. 2 is a perspective view of an example of the optical apparatus 1. As illustrated in FIGS. 1 and 2, the optical apparatus 1 includes: a ball lens 10; at least one optical unit 20; a base 30; and a cover 40.

The ball lens 10 receives and collects transmission light outputted from an external source. The optical unit 20 receives the transmission light having been collected. The base 30 has the ball lens 10 and the optical unit 20 mounted thereon. The cover 40 engages with the base 30 to house the ball lens 10 and the optical unit 20. The optical unit 20 includes a magnet 21, and is mounted on the base 30 so as to be capable of rotating around the ball lens 10 in response to magnetic force by which the magnet 21 is attracted.

(Adjustment Method)

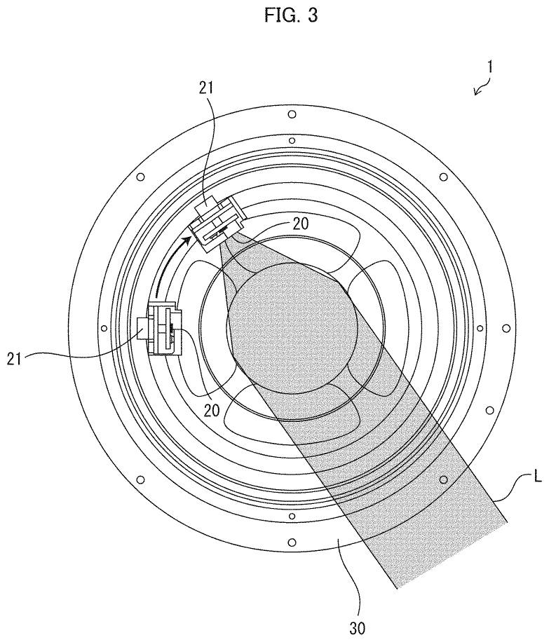

A method for adjusting the position of the at least one optical unit 20 of the optical apparatus 1 in accordance with the present example embodiment will be described below, with reference to FIG. 3. FIG. 3 is a top view of an example of the optical apparatus 1.

In the adjustment method, by causing the magnet 21 to be attracted by magnetic force exerted from outside the cover 40, the optical unit 20 rotates around the ball lens 10. With this configuration, the position of the optical unit 20X is adjusted so as to be in a specific position at which the transmission light L having been received and collected by the ball lens 10 is received, as illustrated in FIG. 3.

### Example Advantages of First Example Embodiment

Employed in the present example embodiment is a configuration in which the optical apparatus 1 includes the ball lens 10, the at least one optical unit 20, the base 30, and the cover 40, and the optical unit 20 is mounted on the base 30 so as to be capable of rotating around the ball lens 10 in response to the magnetic force by which the magnet 21 is attracted.

With this configuration, by simply causing the magnet 21 to be attracted by magnetic force exerted from outside the cover 40, the optical unit 20 rotates around the ball lens 10, thereby allowing adjustment of the position of the optical unit 20. Thus, the present example embodiment produces an example advantage of making it possible to provide an optical apparatus 1 and related techniques, the optical apparatus 1 allowing easy adjustment of the position of the optical unit 20.

The present example embodiment produces another example advantage of making it possible to provide an optical apparatus 1 and related techniques, the optical apparatus 1 requiring no tool for adjusting the position of the optical unit 20, thereby allowing an improvement in work efficiency. The present example embodiment produces another example advantage of making it possible to provide an optical apparatus 1α, etc. that allow adjustment of the position of the optical unit 20 while maintaining airtightness, whether outdoors or in any other location. The present example embodiment produces still another example advantage of making it possible to provide an optical apparatus 1, etc. that allow adjustment of the position of the optical unit 20 without removal of the fixing portion 100 such as screw. The present example embodiment produces yet another example advantage of making it possible to provide an optical apparatus 1, etc. that allow adjustment of the position of the optical unit 20 without the use of a movable section such as a motor, thereby extending the life of the optical apparatus 1.

### Second Example Embodiment

The following description will discuss a second example embodiment of the present invention in detail, with reference to the drawings. The same reference sign is assigned to a component that has the same function as the component described in the first example embodiment, and the description thereof is omitted where appropriate.

(Configuration of Optical Apparatus 1α)

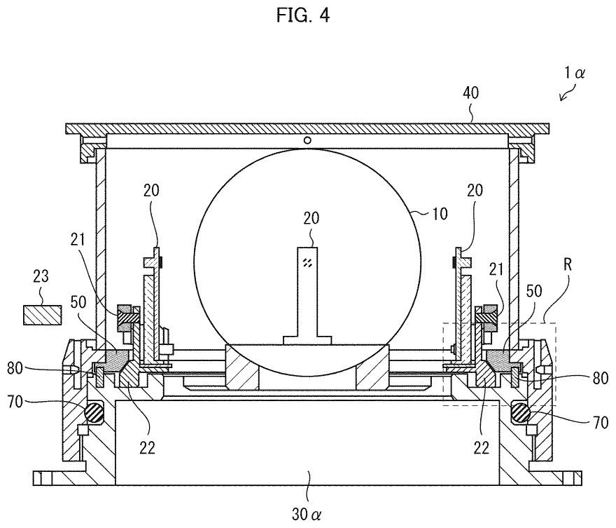

The configuration of an optical apparatus 1α in accordance with the present example embodiment will be described below, with reference to FIG. 4. FIG. 4 is a sectional side view of an example of the optical apparatus 1α. In the example illustrated in FIG. 4, the optical apparatus 1α includes a base 30α instead of the base 30 of the first example embodiment, and further includes a fixing portion (fixing means) 50 for fixing the position of the optical unit 20. The base 30α and the fixing portion 50 will be later described in detail. As illustrated in FIG. 4, the optical apparatus 1α may further include: a waterproofing portion (waterproofing means) 70; and a nonslip portion (nonslip means) 80.

The waterproofing portion 70 is attached to the base 30α for making the optical apparatus 1α waterproof. Examples of the waterproofing portion 70 include an O-ring. The nonslip portion 80 fixes the position of the fixing portion 50 from the base 30α-side (from below) in order to prevent the fixing portion 50 from slipping and thereby rotating when the cover 40 is closed or loosened. Examples of the nonslip portion 80 include a fixing pin.

(Assembly Method)

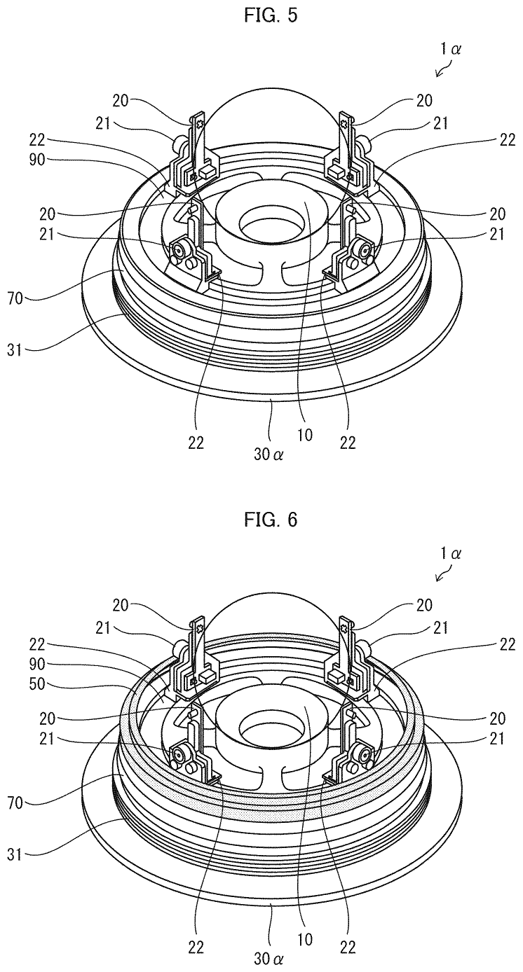

The method, in accordance with the present example embodiment, for assembling the optical apparatus 1α will be described below, with reference to FIGS. 5 to 8. FIGS. 5 to 8 are perspective views of an example of the optical apparatus 1α. In the example illustrated in FIG. 5, the base 30α has a groove 90 formed around the part in which the ball lens 10 is mounted, and has formed therein a threaded engaging portion 31 designed to engage with the cover 40.

First, a user of the optical apparatus 1α installs at least one optical unit 20 on the base 30α such that an abutting part 22 which forms a part of the optical unit 20 is inserted in the groove 90. In the example illustrated in FIG. 5, the user mounts four optical units 20 in the groove 90 of the base 30α so as to enable the four optical units 20 to rotate around the ball lens 10 independently of each other. As above, a plurality of optical units 20 may be mounted on the base 30α so as to be capable of rotating around the ball lens 10 independently of each other.

Next, the user attaches the fixing portion 50 to the outside of the groove 90, from above the base 30α (FIGS. 5 and 6). In the example illustrated in FIG. 6, the fixing portion 50 is a fixing ring. As illustrated in this example, the fixing portion 50 may be a ring-shaped member.

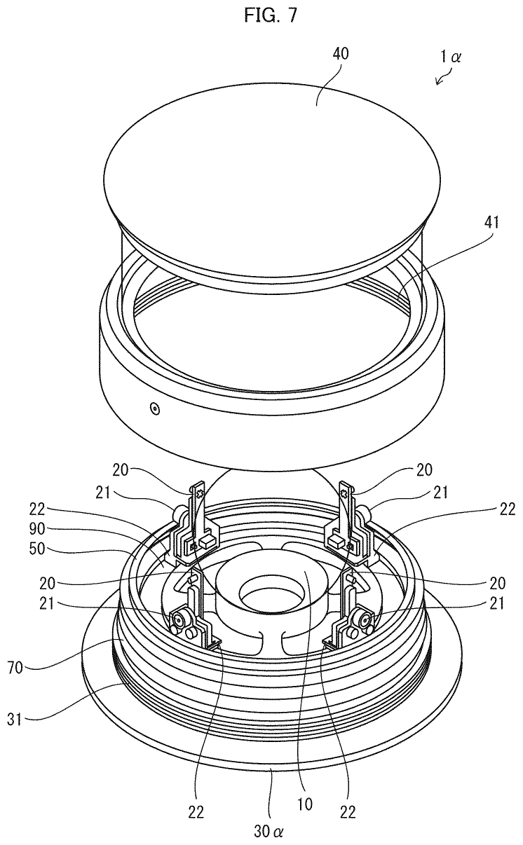

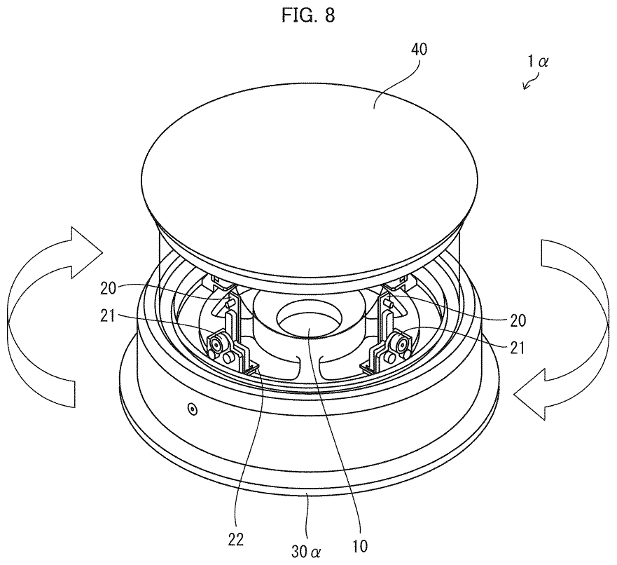

Next, the user attaches the cover 40 to the base 30α (FIGS. 7 and 8). In the example illustrated in FIG. 7, the base 30α is provided with the threaded engaging portion 31, which is designed to engage with the cover 40, and the cover 40 is provided with a threaded engaging portion 41 designed to engage with the base 30α. In this case, the user twists the cover 40 in the direction indicated by the arrows, i.e., clockwise to screw the cover 40 onto the base 30α, so that the cover 40 is closed and engages with the base 30α, as illustrated in FIG. 8.

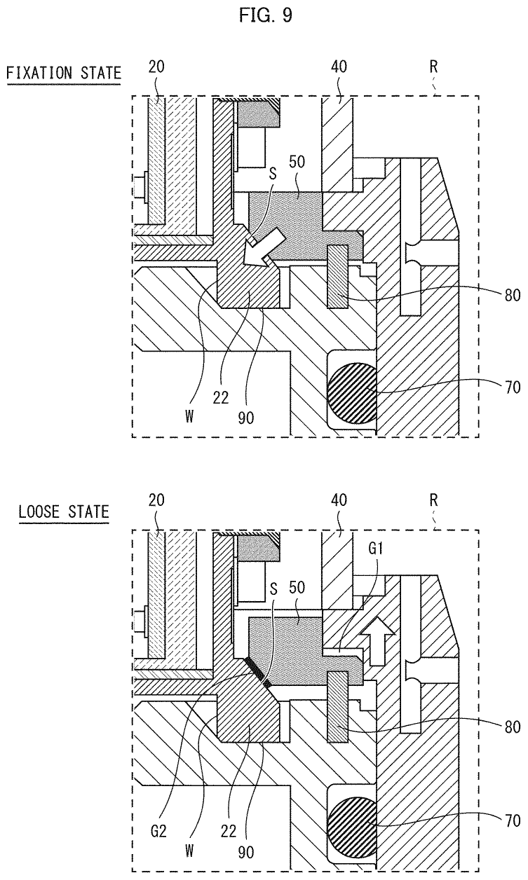

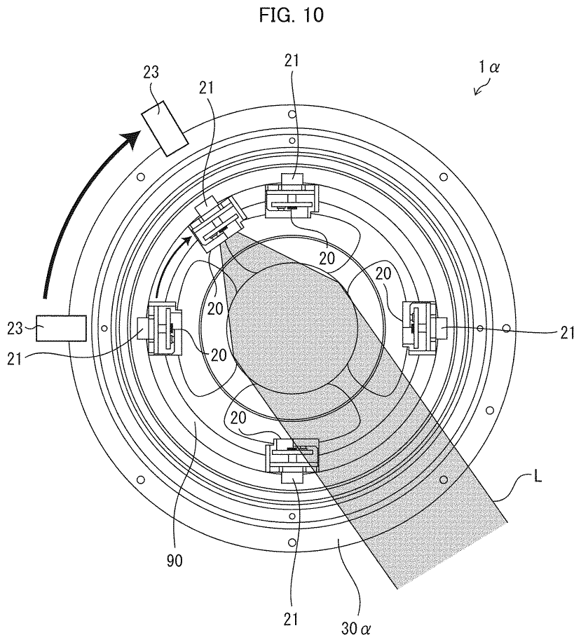

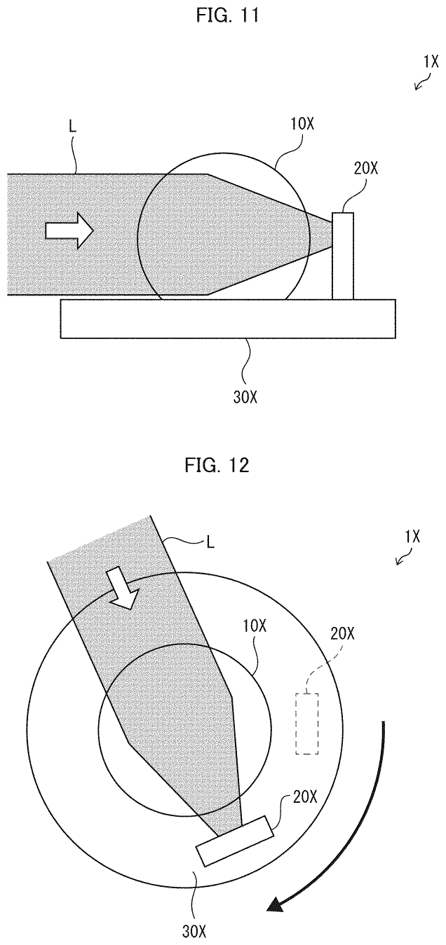

As above, the fixing portion 50 may be designed such that when the cover 40 engages with the base 30α, the fixing portion 50 is pressed by the cover 40, and in turn presses the optical unit 20 to fix the position of the optical unit 20. The fixation, by the fixing portion 50, of the position of the optical unit 20 will be described below, with reference to FIG. 9. FIG. 9 is an enlarged sectional side view of an example of a region R that includes the fixing portion 50 of the optical apparatus 1α.

For example, the fixing portion 50 may be pressed by the cover 40 that is in contact with the upper face of the fixing portion 50, through the engagement of the cover 40 with the base 30α, as illustrated in FIG. 9. Accordingly, the fixing portion 50 may at least partially abut on a slope S of the optical unit 20, the slope S being on the opposite side of the optical unit 20 from the ball lens 10, to press the optical unit 20 toward the base 30α. In this case, the fixing portion 50 applies force to the slope S in the direction indicated by the arrow illustrated in the diagram of a fixation state in FIG. 9. This generates force in the direction (inward) of the base 30α-side of the optical unit 20, and the abutting part 22 is thus pushed against an inner wall W of the groove 90. As a result, the position of the optical unit 20 is fixed.

(Adjustment Method)

A method, in accordance with the present example embodiment, for adjusting the optical apparatus 1α will be described below, with reference to FIG. 4 and FIGS. 8 to 10. FIG. 10 is a top view of an example of the optical apparatus 1α.

First, the user of the optical apparatus 1α loosens the cover 40. In the example illustrated in FIG. 8, since the cover 40 engages with the base 30α via the threaded engaging portions 31 and 41, the user manually twists the cover 40 in a direction opposite to the direction indicated by the arrow illustrated in FIG. 8, i.e., counterclockwise, to loosen the cover 40.

This causes the cover 40 to move in the upper direction indicated by the arrow illustrated in the diagram of a loose state in FIG. 9, a first gap G1 is thus generated between the cover 40 and the fixing portion 50, and the fixing portion 50 is thus released from the press by the cover 40 to move in the upper direction, as illustrated in the diagram of the cover 40 in the loose state in FIG. 9. As a result, a second gap G2 is generated between the fixing portion 50 and the optical unit 20, and the press and fixation of the optical unit 20 by the fixing portion 50 are thus released. This makes the optical unit 20 capable of rotating.

Next, the user of the optical apparatus 1α causes the magnet 21 to be attracted by magnetic force exerted from outside the cover 40. For example, the user moves, outside the cover 40, a magnet 23 closer to the magnet 21, the magnet 23 being intended for adjustment of the position of the optical unit 20, as illustrated in FIG. 4. As illustrated in FIG. 10, in a case of using a plurality of optical units 20, the user may move the magnet 23 closer to the magnet 21 that is provided on the back face of the optical unit 20 that is the closest to the transmission light L outputted from an external source. The polarities of the magnets 21 and 23 are not limited to any particular polarities, provided that the polarities produce attraction between the magnets 21 and 23. For example, the polarity of the magnet 21 and the polarity of the magnet 23 may be N and S, respectively, or may be S and N, respectively. The magnetic force of the magnets 21 and 23 only need to be strong enough that the magnets 21 and 23 are attracted to each other through the cover 40.

Subsequently, when the user of the optical apparatus 1α rotates the magnet 23 in, for example, the direction indicated by the arrow in FIG. 10, the optical unit 20 rotates around the ball lens 10 along the groove 90 in the direction indicated by the arrow in FIG. 10, in response to the magnetic force by which the magnet 21 is attracted to the magnet 23. As a result, the position is adjusted.

When the user closes the cover 40 after adjusting the position of the optical unit 20, the position of the optical unit 20 is fixed in the adjusted position by the fixing portion 50, as in the above assembly method (FIG. 5).

### Example Advantages of Second Example Embodiment

A configuration employed in the present example embodiment is as follows: the base 30α has the groove 90 formed around the part in which the ball lens 10 is mounted, the abutting part 22, which forms a part of the optical unit 20, is inserted in the groove 90, so that the optical unit 20 is capable of rotating around the ball lens 10 along the groove 90.

With this configuration, by simply causing the magnet 21 to be attracted by magnetic force exerted from outside the cover 40, the optical unit 20 rotates around the ball lens 10 along the groove 90. The present example embodiment thus produces, in addition to the example advantages of the first example embodiment, an example advantage of making it possible to provide an optical apparatus 1 and related techniques, the optical apparatus 1 allowing easier adjustment of the position of the optical unit 20.

A configuration employed in the present example embodiment is as follows: the optical apparatus 1α further includes the fixing portion 50 designed such that when the cover 40 engages with the base 30α, the fixing portion 50 is pressed by the cover 40, and in turn presses the optical unit 20 to fix the position of the optical unit 20.

With this configuration, it is possible to fix the position of the optical unit 20, by the user simply closing the cover 40 which is in a loose state, without removing the cover 40. The present example embodiment thus produces, in addition to the example advantages of the first example embodiment, an example advantage of making it possible to provide an optical apparatus 1α, etc. that allow fixation of the position of the optical unit 20 while maintaining airtightness, whether outdoors or in any other location.

A configuration employed in the present example embodiment is as follow: the fixing portion 50 is designed to at least partially abut on a slope S of the optical unit 20, the slope S being on the opposite side of the optical unit 20 from the ball lens 10, to press the optical unit 20 toward the base 30a.

With this configuration, when the cover 40 is closed, the fixing portion 50 presses the optical unit 20, and when the cover 40 is loosened, the fixing portion 50 is released from the press by the cover 40, and the optical unit 20, in turn, is release from the press by the fixing portion 50 to become capable of rotating. Thus, the present example embodiment produces, in addition to the example advantages of the first example embodiment, an example advantage of making it possible to provide an optical apparatus 1α and related techniques, the optical apparatus 1α allowing fixation and release of the fixation of the position of the optical unit 20 while maintaining airtightness, by simply closing and loosening the cover 40.

A configuration employed in the present example embodiment is that the fixing portion 50 is a ring-shaped member.

With this configuration, it is possible to use a ring-shaped member as the member suitable for a fixing portion 50 which is designed to at least partially abut on a slope S of the optical unit 20, the slope S being on the opposite side of the optical unit 20 from the ball lens 10, to press the optical unit 20 toward the base 30α. Thus, the present example embodiment produces, in addition to the example advantages of the first example embodiment, an example advantage of allowing use of the member, as described above, suitable for the fixing portion 50.

A configuration employed in the present example embodiment is that a plurality of optical units 20 are mounted on the base 30α so as to be capable of rotating around the ball lens 10 independently of each other.

With this configuration, it is possible to adjust the position of the optical unit 20 that is the closest to the transmission light L outputted from an external source. Thus, the present example embodiment produces, in addition to the example advantages of the first example embodiment, an example advantage of allowing easier adjustment of the position of the optical unit 20.

(Variation of Fixing Portion 50)

In the above examples, a fixing ring is applied to the fixing portion 50, which is designed to at least partially abut on a slope S of the optical unit 20, the slope S being on the opposite side of the optical unit 20 from the ball lens 10, to press the optical unit 20 toward the base 30α. However, in the present example embodiment, the fixing portion 50 having such a function is not limited to a fixing ring, but any member that has such a function may be employed. This also produces an example advantage that is the same as the one produced when the fixing portion 50 is a fixing ring.

(Variation of Nonslip Portion 80)

In the above examples, a fixing pin is applied to the nonslip portion 80, which fixes the position of the fixing portion 50 from the base 30α-side (from below) in order to prevent the fixing portion 50 from slipping and thereby rotating when the cover 40 is closed or loosened. However, in the present example embodiment, the nonslip portion 80 having such a function is not limited to a fixing pin, but any nonslip portion 80 that has such a function, such as a screw, can be employed. When the nonslip portion 80 has such a function, an example advantage that is the same as the one produced when the nonslip portion 80 is a fixing pin is produced.

[Additional remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional remark 2]

Some or all of the foregoing example embodiments can also be described as below. Note, however, that the present invention is not limited to the following example aspects.

(Supplementary note 1)

An optical apparatus including: a ball lens that receives and collects transmission light outputted from an external source; at least one optical unit that receives the transmission light having been collected; a base on which the ball lens and the at least one optical unit are mounted; and a cover that engages with the base to house the ball lens and the at least one optical unit, the optical unit including a magnet, and being mounted on the base so as to be capable of rotating around the ball lens in response to a magnetic force by which the magnet is attracted.

(Supplementary note 2)

The optical apparatus described in Supplementary note 1, in which the base has a groove formed around a part in which the ball lens is mounted, the at least one optical unit has a part that is inserted in the groove, and the at least one optical unit is capable of rotating around the ball lens along the groove.

(Supplementary note 3)

The optical apparatus described in Supplementary note 1 or 2, further including a fixing means that is designed such that when the cover engages with the base, the fixing means is pressed by the cover, and in turn presses the at least one optical unit to fix a position of the at least one optical unit.

(Supplementary note 4)

The optical apparatus described in Supplementary note 3, in which the fixing means is designed to at least partially abut on a slope of the at least one optical unit, the slope being on an opposite side of the at least one optical unit from the ball lens, to press the at least one optical unit toward the base.

(Supplementary note 5)

The optical apparatus described in Supplementary note 3 or 4, in which the fixing means is a ring-shaped member.

(Supplementary note 6)

The optical apparatus described in any one of Supplementary notes 1 to 5, in which the at least one optical unit includes a plurality of optical units, and the plurality of optical units are mounted on the base so as to be capable of rotating around the ball lens independently of each other.

(Supplementary note 7)

A method for adjusting a position of at least one optical unit included in an optical apparatus, the optical apparatus further including: a ball lens that receives and collects transmission light outputted from an external source; a base on which the ball lens and the at least one optical unit are mounted; and a cover that engages with the base to house the ball lens and the at least one optical unit, the at least one optical unit receiving the transmission light having been collected, the at least one optical unit being mounted on the base so as to be capable of rotating around the ball lens, the at least one optical unit including a magnet, the method comprising causing the magnet to be attracted by magnetic force exerted from outside the cover to rotate the at least one optical unit around the ball lens.

### REFERENCE SIGNS LIST

P 1, 1α, 1X: Optical apparatus
10, 10X: Ball lens
20, 20X: Optical unit
21, 23: Magnet
30, 30α, 30X: Base
40, 40X: Cover
50, 100, 110: Fixing portion (fixing means)
90, 90X: Groove

1. An optical apparatus comprising:
a ball lens that receives and collects transmission light outputted from an external source;
at least one optical unit that receives the transmission light having been collected;
a base on which the ball lens and the at least one optical unit are mounted; and
a cover that engages with the base to house the ball lens and the at least one optical unit,
the at least one optical unit including a magnet, and being mounted on the base so as to be capable of rotating around the ball lens in response to magnetic force by which the magnet is attracted.

2. The optical apparatus according to claim 1, wherein
the base has a groove formed around a part in which the ball lens is mounted,
the at least one optical unit has a part that is inserted in the groove, and
the at least one optical unit is capable of rotating around the ball lens along the groove.

3. The optical apparatus according to claim 2, further comprising
a fixing portion that is designed such that when the cover engages with the base, the fixing portion is pressed by the cover, and in turn presses the at least one optical unit to fix a position of the at least one optical unit.

4. The optical apparatus according to claim 3, wherein
the fixing portion is designed to at least partially abut on a slope of the at least one optical unit, the slope being on an opposite side of the at least one optical unit from the ball lens, to press the at least one optical unit toward the base.

5. The optical apparatus according to claim 4, wherein
the fixing portion is a ring-shaped member.

6. The optical apparatus according to claim 1, wherein
the at least one optical unit includes a plurality of optical units, and the plurality of optical units are mounted on the base so as to be capable of rotating around the ball lens independently of each other.

7. A method for adjusting a position of at least one optical unit included in an optical apparatus,
the optical apparatus further including:
a ball lens that receives and collects transmission light outputted from an external source;
a base on which the ball lens and the at least one optical unit are mounted; and
a cover that engages with the base to house the ball lens and the at least one optical unit,
the at least one optical unit receiving the transmission light having been collected,
the at least one optical unit being mounted on the base so as to be capable of rotating around the ball lens,
the at least one optical unit including a magnet,
the method comprising
causing the magnet to be attracted by magnetic force exerted from outside the cover to rotate the at least one optical unit around the ball lens.
